(19) United States
(12) Patent Application Publication
(10) Pub. No.: US 2007/0035372 A1
(43) Pub. Date: Feb. 15, 2007

(54) Surface mount transformer

(76) Inventors: Asao Ishikawa, Tokyo-To (JP); Yuji Ichikawa, Tokyo-To (JP)

Correspondence Address: JACOBSON HOLMAN PLLC, 400 SEVENTH STREET N.W., SUITE 600, WASHINGTON, DC, 20004, US

(21) Appl. No.: 11/435,786

(22) Filed: May 18, 2006

(30) Foreign Application Priority Data
Aug. 9, 2005 (JP) U 2005-006431

(51) Int. Cl. H01F 27/02

(52) U.S. Cl. 336/83

(57) ABSTRACT

It is intended to provide a surface mount transformer which can be mounted without affecting the configuration of the wiring pattern of a printed wiring board. For that purpose, the transformer includes, a transformer body 10 configured by winding a winding on a ferrite core, and a seating 20 that has an insulating substrate 21 having a size necessary to place said transformer body thereon, a wiring pattern formed on at least one surface thereof, and connection terminals 22 for connecting the edges of the winding formed on the circumference of said insulating substrate.

### BACKGROUND OF THE INVENTION

1. Field of the Invention

The present invention relates to a high frequency transformer to be mounted on a surface, especially to a transformer using a ferrite core.

2. Related Art

In conventional transformer mounted on a printed wiring board, as shown in FIGS. 6A, 6B, electrical and mechanical mounting is carried out by connecting by soldering edges drawn from a winding 20 of a transformer 10 to terminals formed using a wiring pattern of the printed wiring board 30 (see Japanese Patent Laid-Open No. 2002-271161).

As shown in FIG. 6, if the edges of the winding 20 are connected to a wiring pattern of the printed wiring board 30, when a wiring pattern for connecting the edges of the winding 20 is formed, the part to be provided with the wiring pattern cannot be provided with a ground wiring pattern. This will affect large influence on the high-frequency properties of the printed wiring board, thereby there is a problem in designing the printed wiring board.

Therefore, in order to ensure high-frequency properties, in the above mentioned Japanese Patent Laid-Open No. 2002-271161, a metal plate 40 is added so as to compensate the ground wiring pattern, and the printed wiring board is provided with terminals for connecting the metal plate.

However, preparing the metal plate separately to the printed winding board, and providing terminals for connecting the metal plate to the printed winding board, and further using them to carry out connection, increase the parts number and cause the operation to be complex.

### SUMMARY OF THE INVENTION

The present invention aims to provide a surface mount transformer which can be mounted without affecting the configuration of the wiring pattern of the printed wiring board.

In order to achieve the above mentioned object, the present invention provides a surface mount transformer which includes:

a transformer body that is configured by winding a winding on a ferrite core, and,

a seating that has an insulating substrate having a size necessary to place said transformer body and a wiring pattern formed on at least one surface thereof, and connection terminals for connecting the edges of said winding are formed on the circumference of said insulating substrate.

As mentioned above, in the present invention, since the transformer body is combined to the seating having a wiring pattern formed on at least one surface thereof, the connection terminals are provided to the surface mount transformer itself, thereby, it is not necessary to form connection terminals and metal plate connection terminals on the printed wiring board on which the transformer body is mounted, thereby resulting in an extreme convenience in designing the printed wiring board.

### BRIEF DESCRIPTION OF THE DRAWINGS

FIG. 1 is an explanation view showing a configuration of one embodiment according to the present invention;

FIG. 2 is an explanation view showing another configuration of one embodiment according to the present invention;

FIGS. 3A, 3B are explanation, views showing a configuration example of a seating used in the present invention;

FIG. 4 is an explanation view showing another configuration example of a seating used in the present invention;

FIGS. 5A, 5B and 5C are explanation views showing a circuit and a terminal structure, respectively, when the present invention is applied to the circuit of a television signal distributor; and

FIG. 6A is a perspective view showing a configuration of a printed wiring board using a conventional ground metal plate, and FIG. 6B is a side view thereof.

### DETAILED DESCRIPTION OF THE INVENTION

Now, referring to the appended drawings, the embodiments of the present invention will be described below.

### Embodiment 1

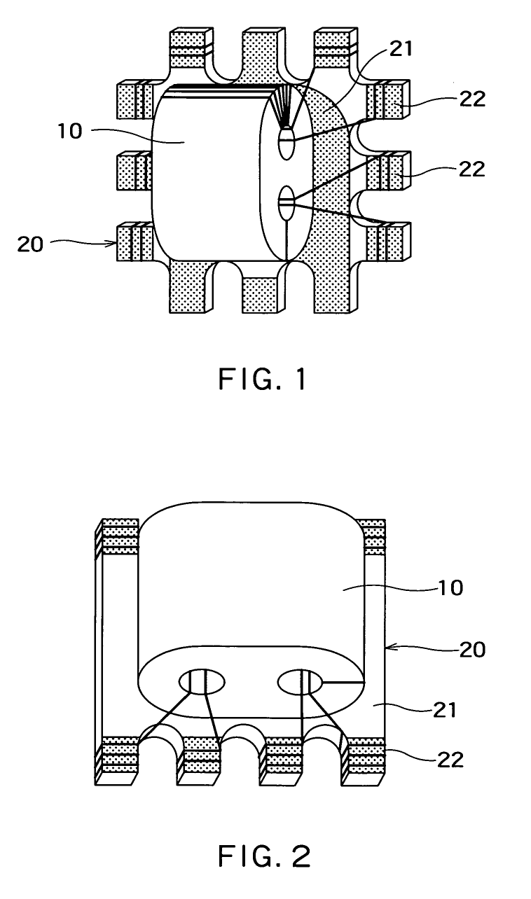

FIG. 1 is a perspective view showing one configuration example of the surface mount transformer according to the present invention. The surface mount transformer is configured with a transformer body 10 and a seating 20. The transformer body 10 is a ferrite core 11 on which a winding 12 is wound, and the edges of the winding 12 are wound on connection terminals 22 provided on the circumference of a part placing part 21 of the seating 20, and finished by soldering.

In the surface mount transformer, the seating 20 is placed on a transformer installing location provided on a printed wiring board (not shown) to connect by soldering the connection terminals 22 of the seating 20 to terminals provided on a wiring pattern of the printed wiring board.

According to the configuration, since the connection terminals are provided to all sides of the seating 20, the degree of freedom in designing the configuration of the wiring pattern of the printed wiring board is large.

FIG. 2 is a perspective view showing another configuration example of the surface mount transformer according to the present invention, and in the configuration example shown in the drawing, the transformer has connection terminals 22 that are provided on two facing sides of the seating 20 and have a rather tapered planar shape.

In the configuration, since the connection terminals 22 are provided on only two sides of the seating 20, it is not necessary to provide a space for connection on parts corresponding to the other two sides of the printed wiring board, to which terminals are not provided, thereby, enabling to reduce the space allocated for connection in the printed wiring board.

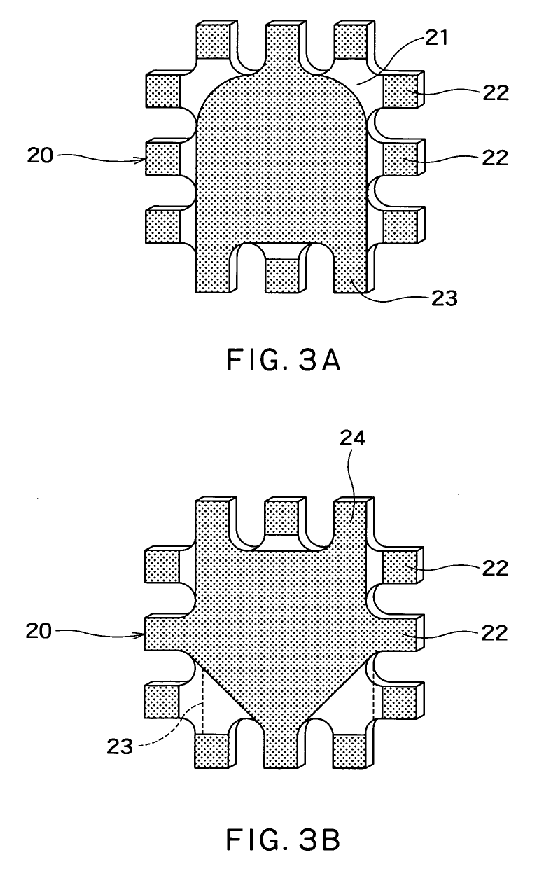

FIGS. 3A, 3B are explanation views of the seating 20, in FIG. 3(A), the side on which a part is placed (surface side) is shown, and in FIG. 3B, the side facing to the printed wiring board (back surface side) that is rotated in right-left direction from the state of FIG. 3A, is shown. As shown in FIG. 3A, the seating 20 supports the transformer body 10 (FIGS. 1, 2) placed on an ground pattern 23 formed on the center of the part placing part 21, and the edges of the winding of the transformer body 10 are wound on the connection terminals 22 provided on the circumference thereof, and soldered. In addition, a solder resist is provided on the part placing part 21, and has the transformer body 10 placed thereon.

On the other hand, as shown in FIG. 3B, a wiring pattern 24 is formed on the back surface side of the seating 20 so as to cover the central part substantially. The wiring pattern 24 connects between terminals and acts as an electrostatic capacitance by cooperating with the ground pattern 23 on the surface side. The value of the electrostatic capacitance is determined by adjusting the facing area between the ground pattern 23 and the wiring pattern 24.

In this manner, the ground pattern provided on one surface of the seating 20 is intended to connect between some ground terminals, and, if it is difficult to provide the ground pattern on the printed wiring board, can also act as alternate ground pattern of the printed wiring board. In addition, since the ground pattern is floated from the printed wiring board by the thickness of the winding wound on the seating, it is not necessary to be insulated by a protective cover or the like.

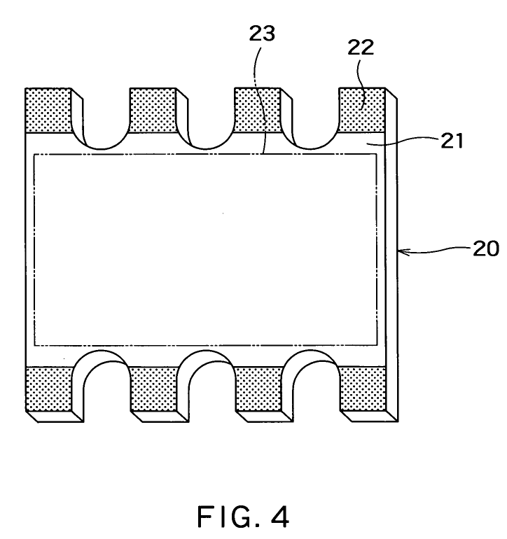

FIG. 4 shows another example of the seating 20. In this case, similar to the example shown in FIG. 2, the connection terminals 22 are provided only on two facing sides of the seating 20, and have side sides with a tapered shape or an inverse tapered shape.

Here, the tapered shape is denoted as a shape, in which the width spreads from the edge to the base of the terminal 22, and the mutual distance between connection terminals 22 becomes narrower from the edge to the base, and on the contrary, the inverse tapered shape is denoted as a shape, in which the width becomes narrower from the edge to the base of the terminal 22, and the mutual distance between connection terminals 22 spreads from the edge to the base. In a tapered shape, soldering work is easily performed, and in the inverse tapered shape winding work of the winding is easily performed.

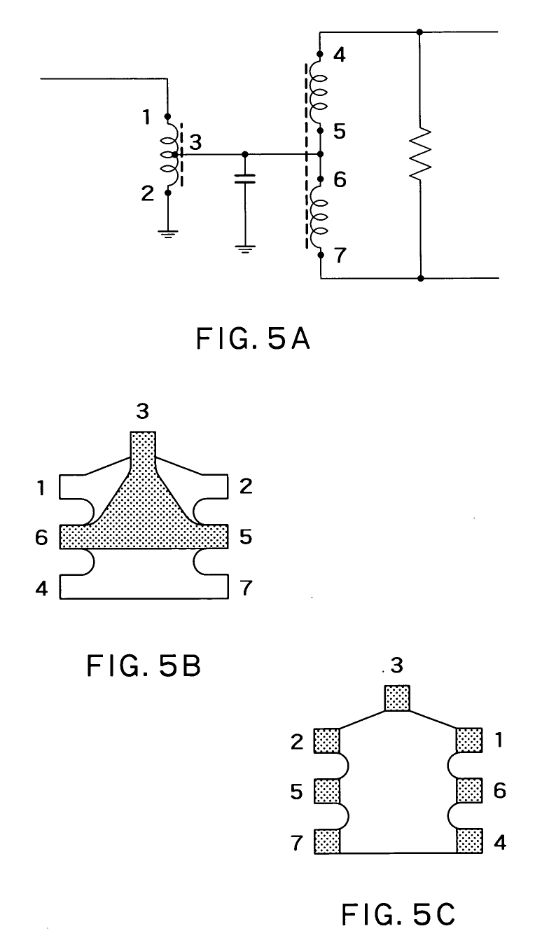

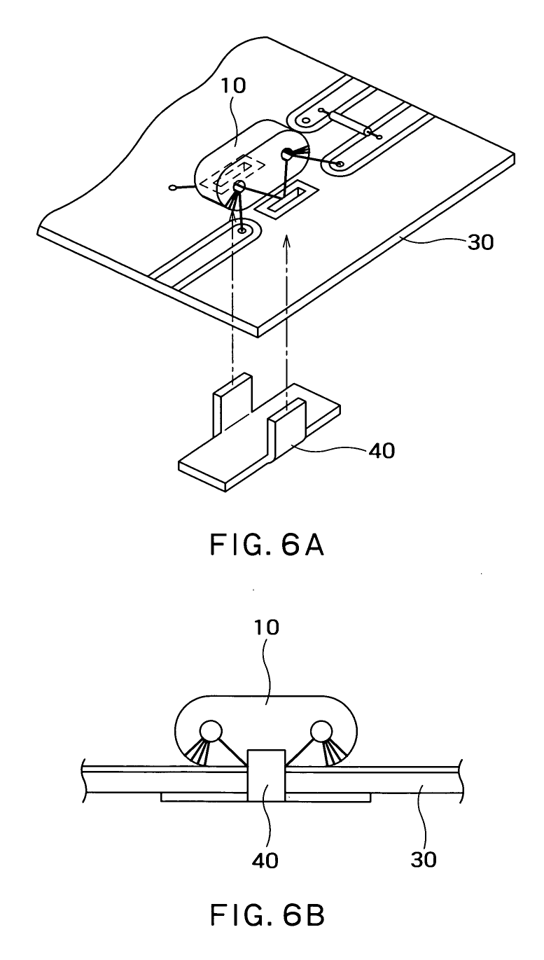

FIGS. 5A to 5C show a combination circuit (FIG. 5A) of an impedance matching transformer and a signal distributing transformer, which is frequently used in a television signal distributor, and the shapes of conductive patterns of the seating (FIGS. 5B, 5C) when the present invention is applied to the signal distributor circuit.

In this circuit, as shown in FIG. 5A, since an intermediate tap 3 of the impedance matching transformer and the winding edges 5, and 6 of the distributing transformer are connected each other, the connection is carried out by a conductive pattern connecting terminals 3, 5, and 6 on the seating. Therefore, a nearly triangle conductive patterns connecting terminals 3, 5, and 6, is formed on the surface side of the seating. On the other hand, respective terminals 1 to 7 are formed on the back surface side of the seating, by individual conductive patterns.

As mentioned above, in the present invention, since a surface mount transformer is configured by using an insulating substrate with a wiring pattern as seating, it is possible to provide a so-called chip type compact transformer with good workability during mounting on the printed wiring board.

What is claimed is:

1. A surface mount transformer including:
a transformer body configured by winding a winding on a ferrite core; and
a seating that has an insulating substrate having a size necessary to place said transformer body thereon and a wiring pattern formed on at least one surface thereof, and connection terminals for connecting the edges of said winding to the circumference of said insulating substrate.

2. The surface mount transformer claimed in claim 1, wherein
said insulating substrate has wiring patterns on both surfaces thereof.

3. The surface mount transformer claimed in claim 1, wherein
the edges of said winding are soldered to said connection terminals.

4. The surface mount transformer claimed in claim 1, wherein
said connection terminals are terminals using said wiring patterns.

5. The surface mount transformer claimed in claim 1, wherein
said wiring patterns are provided on the both surfaces of said insulating substrate; and
one of said wiring patterns is used as ground pattern, and the other winding pattern has an adjustable area.
